(19) United States
(12) Patent Application Publication
(10) Pub. No.: US 2026/0275203 A1
(43) Pub. Date: Sep. 17, 2026

(54) INLINE ELECTRO-COALESCER MULTI-TREATER

(71) Applicant: FMC Separation Systems B.V., Arnhem (NL)

(72) Inventor: Arturo Ernesto Menchaca Lobato, Wageningen (NL)

(21) Appl. No.: 19/076,165

(22) Filed: Mar. 11, 2025

(51) Int. Cl. C10G 33/02

(52) U.S. Cl. CPC C10G 33/02; C10G 2300/1033

(57) ABSTRACT

Systems and methods for separating components of a processing fluid by an inline electro-coalescer (IEC) multi-treater are disclosed. In some embodiments, a processing fluid is received in a processing fluid line of an oil and gas well system, by an oil and gas processing plant, by an oil treatment plant, by an oil refinery, or by other facilities requiring (bulk) oil dehydration and/or oil desalting. Demulsifiers may be injected into the process fluid and the process fluid is provided into a processing chamber for treatment by a combination of providing heat to the process fluid, providing an electric field to the process fluid, and controlling the flow of the process fluid by the geometry of the processing chamber. Furthermore, the process fluid may flow into a separating chamber configured to separate components (e.g., oil and water) of the process fluid.

### BACKGROUND

### 1. FIELD

Embodiments of the current disclosure relate to process fluid treatment in oil and gas systems. More specifically, embodiments of the current disclosure relate to systems and methods of combining a plurality of treatment processes into a single inline electro-coalescer multi-treater.

### 2. RELATED ART

After a process fluid has been obtained from an oil and gas well, the process fluid needs to be treated before use. Various components of the process fluid need to be separated. For example, water may need to be removed from the process fluid to provide a more oil-rich fluid. Typical process fluid treatments include stages of processing performed by separate treatment devices configured to provided additive components, heat the process fluid, and provide electric energy to the process fluid. Each treatment process performed on the process fluid is typically performed by separate devices. As such, each of the treatment devices takes up space and increases complexity by requiring pipes and valves to control the flow of the process fluid through and between the devices.

Furthermore, typical treatment processes require separation in a settling chamber. When the process fluid enters the settling chamber, as described above, the process fluid has typically gone through various treatments such as, for example, emulsion breaking and coalescence, but the process fluid has not yet been separated. As such, a maximum settling time is required to separate components (e.g., oil and water) of the process fluid.

What is needed are systems and methods for increasing separation efficiency and reducing volume, floorspace and weight required for the treatment devices by combining the separate treatment stages and separate treatment devices into a single or reduced number of devices and at least partially separating the process fluid components before settling.

### SUMMARY

Embodiments of the current disclosure solve the above-described problems and provide a distinct advance in the art by providing systems and methods for increasing separation efficiency and reducing volume, floorspace and weight by combining various process fluid treatment stages and treatment devices into a single or reduced number of devices and at least partially separating the process fluid components.

An embodiment of the current disclosure comprises an inline electro-coalescer (IEC) multi-treater. The IEC multi-treater comprises one or more nozzles configured to inject chemicals into a process fluid, one or more pipes comprising a processing chamber configured for the process fluid to flow therethrough, one or more electrodes provided in an electrically insulated sleeve within the processing chamber, wherein the one or more electrodes, in cooperation with the one or more pipes, are configured to provide an electric field through the process fluid in the processing chamber, a heating fluid chamber providing heating fluid proximate to the processing chamber and configured to heat the process fluid in the processing chamber, and a plurality of baffles disposed in the processing chamber and/or the heating chamber and configured to control flow of the process fluid and/or the heating fluid through the processing chamber and/or the heating chamber.

Furthermore, an embodiment of the current disclosure comprises a method of separating a component of a process fluid by an inline electro-coalescer (IEC) multi-treater. The method comprises receiving the process fluid in an inlet, providing chemical demulsifiers to the process fluid, providing the process fluid to a processing chamber, wherein the processing chamber is provided in an electrically grounded pipe, heating the process fluid by a heating fluid flowing through a heating fluid chamber adjacent to the processing chamber, generating an electric field by an electrode in cooperation with the electrically grounded pipe, wherein the electrode is disposed in an electrically-insulated sleeve within the processing chamber, and at least partially separating at least one component from the process fluid in a separating chamber.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1A depicts an embodiment of an inline electro-coalescer (IEC) multi-treater including a single electro-coalescer (EC) cell;

FIG. 1B illustrates an exemplary close-up view of components of an EC cell of the IEC multi-treater;

FIG. 1C illustrates an exemplary heat transfer into the process fluid of the IEC multi-treater;

FIG. 2 depicts the IEC multi-treater including a plurality of EC cells;

FIG. 3 depicts the IEC multi-treater including the single EC cell and a plurality of treatment stages;

FIG. 4A-4C illustrate exemplary results of the IEC multi-treater compared to exemplary results of typical treatment systems and processes; and

FIG. 5 depicts a flow diagram illustrating an exemplary method of processing the process fluid through the IEC multi-treater.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following description of embodiments of the invention references the accompanying illustrations that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense.

In this description, references to “one embodiment”, “an embodiment”, “embodiments”, “various embodiments”, “certain embodiments”, “some embodiments”, or “other embodiments” mean that the feature or features being referred to are included in at least one embodiment of the technology. Separate references to “one embodiment”, “an embodiment”, “embodiments”, “various embodiments”, “certain embodiments”, “some embodiments”, or “other embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments but is not necessarily included. Thus, the current technology can include a variety of combinations and/or integrations of the embodiments described herein.

Generally, embodiments of the current disclosure provide systems and methods for efficiently separating components (e.g., oil and water) of a process fluid from an oil and gas system, including an oil and gas processing plant, an oil treatment plant, an oil refinery, or other facilities requiring (bulk) oil dehydration and/or oil desalting. The process fluid may be provided to an inline electro-coalescer (IEC) multi-treater. Here, the process fluid is an oil-continuous emulsion referenced herein as “emulsion”; however, a water-continuous emulsion is also possible and is discussed in further detail below. In some embodiments, various process fluid treatments may be combined in various combinations within the IEC multi-treater. The treatment processes, in some embodiments, comprise chemical coalescence, heat coalescence, electrical coalescence, flow control, and process fluid component separation. The treatment processes described herein are not limiting and any other process may be implemented.

In some embodiments, chemicals such as, for example chemical demulsifiers, corrosion inhibitors, scale inhibitors, and the like may be injected into the process fluid. For example, chemical de-emulsifiers (“demulsifiers”) may be injected into the process fluid. The demulsifiers may interact with an emulsion of the process fluid emulsion stabilizing layer to allow easier separation of the emulsion components (e.g., oil and water). The demulsifiers may be injected before or at an inlet to the IEC before the processing fluid enters a fluid processing chamber. The demulsifiers weaken the bond between the emulsion components promoting the coalescence of each process fluid component. Exemplary demulsifiers typically used in the oil and gas processing industry that may be used in examples herein include alkoxylated alkylphenol-aldehyde resins, polyalkoxylate block copolymers, polyalkoxylated polyols, polyalkoxylated polyamines. However, any other demulsifiers known in the industry may be used.

In some embodiments, heat may be added to the process fluid to promote emulsion breaking and coalescence of the process fluid components. Heating fluid chambers providing flowing heating fluid (typically water) can be provided adjacent to the process fluid. The heating fluid flowing through the heating fluid chamber can provide heat to the process fluid promoting emulsion breaking and coalescence in the process fluid.

Furthermore, an electromagnetic gradient, electrostatic field, or electric field, may be provided across the process fluid by electro coalescer (EC) cells. The EC cells, in some embodiments, comprise an electrode provided inside a pipe and the pipe is electrically grounded. The process fluid flowing through the processing chamber may be exposed to the electric field provided between the grounded pipe and the electrode. When electrical energy is provided to the electrode, the electric field is generated through the processing chamber and, accordingly, through the process fluid. The flow of the process fluid though the electric field strongly polarizes the water droplets present in the process fluid, which induces strong attractive forces between the water droplets, promoting coalescence.

Furthermore, the process fluid flow may be controlled by the geometry of the processing chamber. For example, baffles may be provided to control the flow of the process fluid to increase the effective residence time in the processing chamber thus, increasing the coalescence. Furthermore, turbulence inducing elements (e.g., corrugated piping and turbulators) may be provided in the processing chamber to induce turbulent flow. Furthermore, in some embodiments, swirl inducers may be provided in IEC multi-treater to creating a swirling action in the flow. The swirling action may force heavier components to the center and lighter components to the outer pipe. Here, slits (e.g., holes) may be provided in a separating chamber to remove the lighter components from the process fluid. After coalescence and separation, the remaining process fluid may be provided into a settling tank to additionally separate and remove the lighter components from the heavier components of the process fluid.

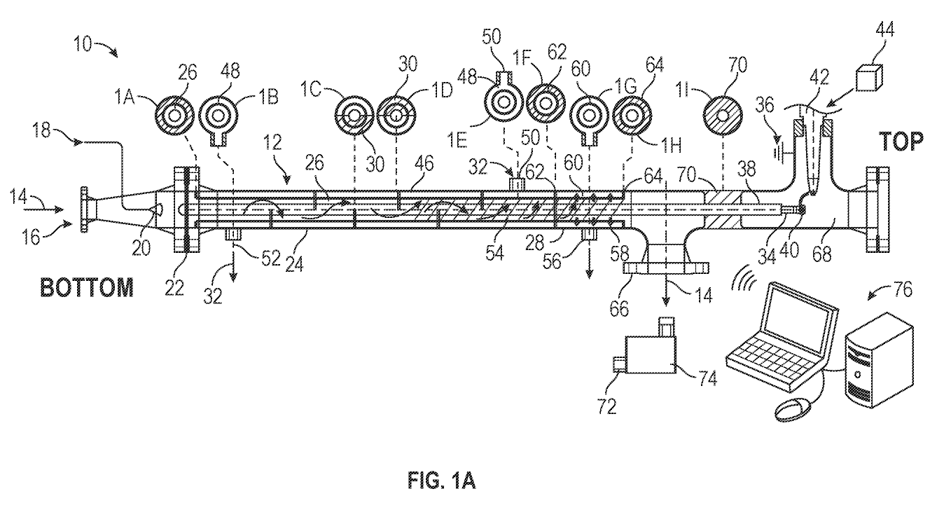

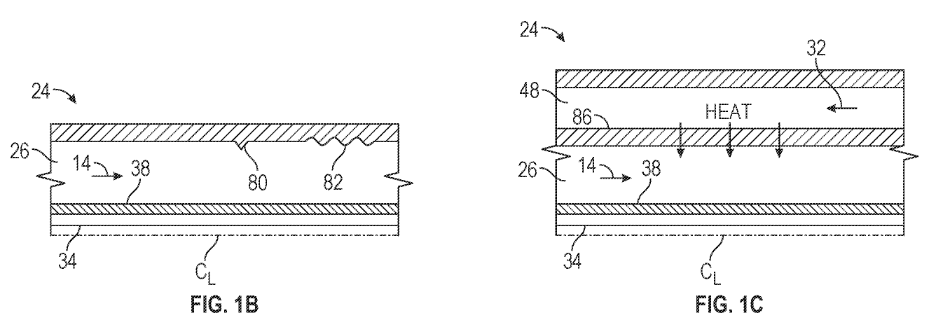

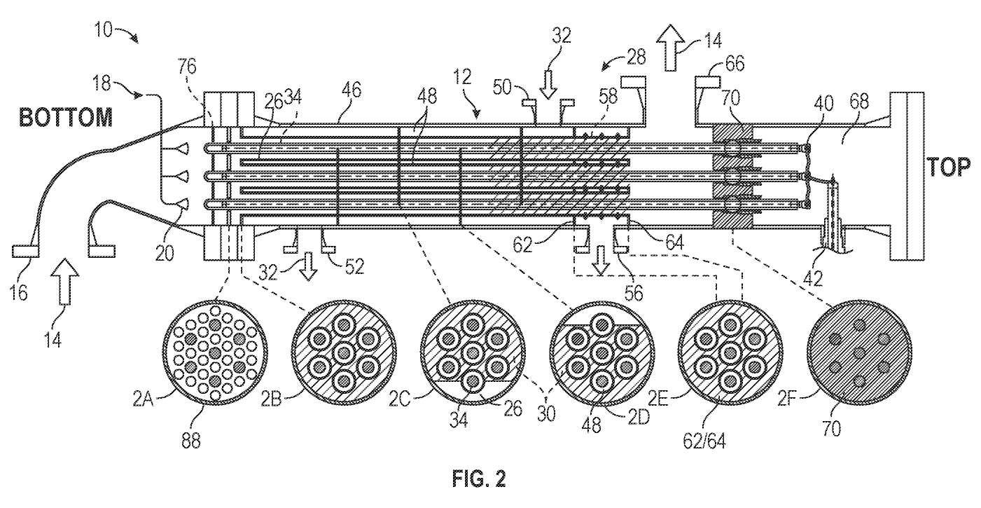

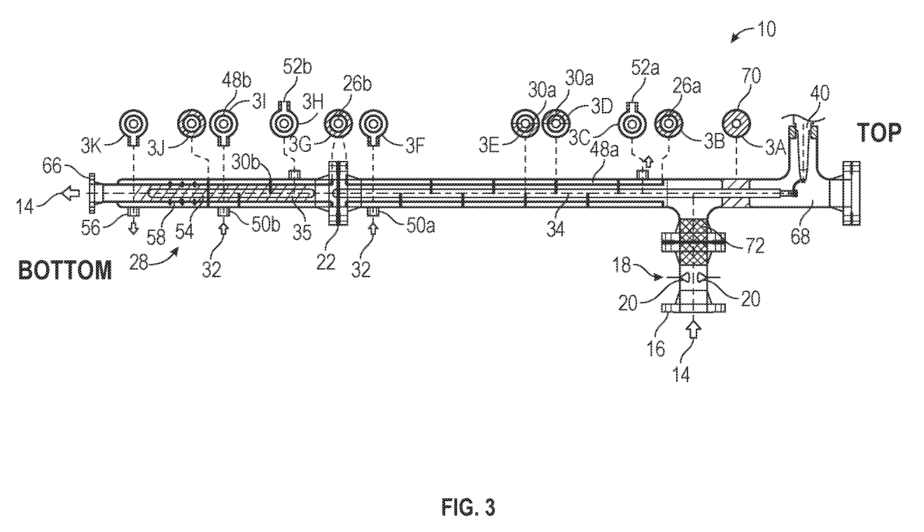

FIG. 1A depicts an embodiment of IEC multi-treater 10. In some embodiments, IEC multi-treater 10 comprises EC cell 12, which is illustrated as a single cell in this embodiment. However, a plurality of EC cells 12 may be provided as illustrated in FIG. 2 and described in detail below. FIG. 1A depicts a side view cross section of IEC multi-treater 10 illustrating the interior components of IEC multi-treater 10. Furthermore, lateral cross-sections at various locations along the length of IEC multi-treater 10 are depicted to illustrate various chamber cross sections and flow of process fluid 14 through the various chambers.

Prior to receiving process fluid 14 into process inlet 16, process fluid 14 may be provided by an upstream oil and gas system including by an oil and gas well, by an oil and gas processing plant, by an oil treatment plant, by an oil refinery, or by other facilities requiring (bulk) oil dehydration and/or oil desalting. At this stage, process fluid 14 may be an emulsion comprising at least oil and water. An exemplary objective of IEC multi-treater 10 is to separate the oil and water through various processes of emulsion breaking, coalescence, and process fluid component separation described below.

At process inlet 16, process fluid 14 may be received into IEC multi-treater 10. Process inlet 16 may be coupled to any line of the oil and gas system described above. Process inlet 16 may be configured to provide process fluid 14 to the interior of IEC multi-treater 10 where process fluid 14 undergoes emulsion breaking, coalescence of the process fluid components, and separation of the process fluid components. As shown in FIG. 1A, the cross-sectional area of process inlet 16 increases from the inlet region to the fluid treatment region (e.g., processing chamber 26). Generally, as the cross-sectional area increases the fluid velocity decreases. Decreasing the velocity of the process fluid 14 may be advantageous to increase residence time of the process fluid 14 in IEC multi-treater 10. As described above, the higher the residence time the more emulsion breaking and coalescence that can occur. As used herein, the effective residence time describes an amount of time that a sample of the process fluid 14 is in the processing chamber 26, the processing chamber 26 and the separating chamber 28 at cross section 1G, or, in some embodiments, the total time within the IEC multi-treater 10. The effective residence time may be increased by controlling the flow of the process fluid 14 by the geometry of IEC multi-treater 10 and opening and closing valves in and out of IEC multi-treater 10. Various flow control methods are described in detail below.

As described above, an exemplary objective of the current disclosure is to combine what are typically separate processes into a single in-line process. In the embodiment depicted in FIG. 1A, chemicals (e.g., demulsifiers 18 and/or wash water injection for crude oil desalting) may be injected into process fluid 14. Though demulsifiers 18 are described herein, it should be noted that any chemicals can be injected into process fluid 14 by nozzles 20. For example, wash water can be injected during desalting of crude oil.

In some embodiments, demulsifiers 18 may be injected by nozzles 20 into the process fluid 14 before or after electrode centralizer 22. Demulsifiers 18 may be more highly pressurized than process fluid 14 to pump the demulsifiers 18 into the process fluid 14, which, at this point and in this example, is a water and oil emulsion. As described above, demulsifiers 18 may include alkoxylated alkylphenol-aldehyde resins, polyalkoxylate block copolymers, polyalkoxylated polyols, polyalkoxylated polyamines, and any other demulsifiers in the industry. Demulsifiers 18 may be configured to weaken the stabilizing layer between the oil and water, or any other process fluid components, to promote breaking of the emulsion and promote coalescence.

In some embodiments, turbulence-inducing features, such as tubesheet 88, a static mixer, or other turbulence-inducing feature, may be placed between nozzles 20 and processing chamber 26, or within process chamber 26, to promote the interaction between the injected chemical and the process fluid to increase chemical treatment efficiency. In some embodiments, it is important that water droplets entering the process chamber do not exceed a certain critical size, beyond which, in the presence of the electric field, they become structurally unstable and break up to form very many small droplets. The breaking up of droplets caused by these processes result in extremely tight emulsions that can be much more difficult to break. The turbulence-inducing features described herein, for example porous media with relatively coarse porosity, can be used to control the size of the water droplets prior treatment by EC cell 12.

As process fluid 14 mixes with demulsifiers 18 the mixture may be passed through electrode centralizer 22, which may comprise tubesheet 88 (depicted in FIG. 2 and described in detail below). Tubesheet 88 may further aid in mixing demulsifiers 18 with process fluid 14. Electrode centralizer 22 may be provided to support and locate electrode 34 in the center of pipe 24 and in the center of IEC multi-treater 10 housing 46. Furthermore, in the embodiment, tubesheet 88 may not be present or may be provided in a different location. When demulsifiers 18 are added, the demulsifiers begin weakening and breaking the emulsion of process fluid 14 allowing process fluid 14 components to separate from the emulsion. In the case of a water and oil emulsion, breaking the stabilizing layer of the emulsion allows the water droplets to coalesce downstream.

After process fluid 14 passes electrode centralizer 22, process fluid 14 enters processing chamber 26 configured between cross-section 1A and cross-section 1I. In processing chamber 26, process fluid 14 undergoes various processes for breaking the emulsion, promoting coalescence, and separating the process fluid components. In some embodiments, the flow of process fluid 14 is controlled by the geometry of IEC multi-treater 10 comprising turbulence inducing features, heat can be added by heating fluid 32, and process fluid 14 may be acted upon by an electric field while in processing chamber 26.

In some embodiments, process fluid 14 may be influenced by the electric field applied by the interaction (e.g., cooperation) between electrode 34 comprising a voltage and pipe 24 connected to electric ground 36. Here, IEC multi-treater 10 comprises a single EC cell 12; however, as described below and illustrated in FIG. 2, IEC multi-treater 10 may comprise a plurality of EC cells 12. In some embodiments, EC cell 12 comprises electrode 34, electrically-insulated sleeve 38, pipe 24, electrical connector 40, penetrator 42, and power source 44, as well as any other components that may be useful in providing the electric field to process fluid 14. Electrode 34 may be energized by power source 44 and, by interacting with pipe 24, generate an electric field. As such, the interaction between the electrode 34 provided in the electrically-insulated sleeve 38 and disposed within pipe 24 may generate an electric field through process fluid 14 in processing chamber 26. In some embodiments, electrode 34 comprises a conductive material such as, for example, copper, titanium, silver, graphite, brass, and/or any other material that conducts electricity.

In some embodiments, EC cell 12 comprises electrically-insulated sleeve 38, which is depicted in more detail in FIG. 1B. Sleeve 38 may comprise various non-conductive materials including polymer, ceramic, rubber, and the like. Sleeve 38 may be liquidtight and, in some embodiment, gastight. Sleeve 38 may be configured to prevent process fluid 14 from leaking from processing chamber 26 to the interior of sleeve 38 housing electrode 34. In some embodiments, sleeve 38 may interact with the electric field generated by electrode 34 and pipe 24. In some embodiments, sleeve 38 does not interact with the electric field. In some embodiments sleeve 38 may be partly made of an electrically conducting material. Furthermore, as describe below, sleeve 38 may comprise various turbulence inducing features to disrupt laminar flow and generate turbulence in the flow of process fluid 14.

In some embodiments, electrode 34 comprises an electrically conductive material such as metal, graphite, or the like. Power source 44 may provide electrical energy to electrode 34 by way of penetrator 42 and electrical connector 40 (in some embodiments, comprising a plurality of connectors) disposed in electric chamber 68. As described above, the interaction between electrically powered electrode 34 and pipe 24 generates the electric field across process fluid 14. The electric field provided by EC cell 12 may induce electro-coalescence of for example water droplets in process fluid 14. In some embodiments, an electric field gradient may increase from the weakest point near pipe 24 to a strongest point near the interior wall of sleeve 38. A stronger electric field increases the likelihood of coalescence. As process fluid 14 passes through processing chamber 26 and the electric field provided by EC cell 12, the water droplets present in the process fluid 14 polarize, which induces strong attractive forces between the water droplets, coalescing them. Therefore, the electric field generated by EC cell 12 promotes coalescence in process fluid 14.

In some embodiments, baffles 30 and/or distributors (e.g., tubesheet 88) may be made of an electrically conductive material and connected to pipe 24 such that all distributors and pipe 24 are grounded by electric ground 36. Alternatively, baffles 30 and/or distributors may comprise electrically insulating material such that no or little electrical current is passed therethrough. Baffles 30, shown in FIG. 1A at cross sections 1C and 1D, may be provided in an alternating pattern interrupting the flow of the process fluid 14. Baffles 30 may force the flow to rotate around sleeve 38 housing electrode 34 such that the process fluid 14 flows in a corkscrew-like shape along the longitudinal length of the IEC multi-treater 10 from process inlet 16 before turning to exit at process outlet 66. Baffles 30 may also be disposed in a different configuration, for example to force the flow into an undulating, zigzag or some other suitable path. The controlled flow of process fluid 14 increases the effective length of the processing chamber 26 and, accordingly, the travel distance of process fluid 14 through IEC multi-treater 10. Increasing the travel distance effectively increases the effective residence time (i.e., the time that a typical particle of process fluid 14 takes to track from cross-section 1A to cross-section 1I).

Continuing with the embodiment depicted in FIG. 1A, heating fluid 32 may be provided in heating fluid chamber 48. As shown at cross-section 1A, process fluid 14 is provided into processing chamber 26. Here, processing chamber 26 is enclosed by heating fluid chamber 48 provided between processing chamber 26 and inner wall of pipe 24. In some embodiments, pipe 24 may comprise heating fluid chamber 48 as heating fluid chamber 48 may be provided between processing chamber 26 and the outer wall of pipe 24.

In some embodiments, heating fluid chamber 48 may comprise various heating fluid inlets and outlets configured to receive and expel heating fluid 32. For example, heating fluid inlet 50 may be configured to receive heating fluid 32 into heating fluid chamber 48. Heating fluid 32 may flow, as shown, in an opposite direction as process fluid 14 and exit heating fluid chamber 48 at heating fluid outlet 52. It may be more efficient to flow heating fluid 32 in opposition to the flow of process fluid 14 as shown in FIG. 1A; however, in some embodiments, heating fluid 32 may flow in the same direction as process fluid 14. For example, heating fluid 32 may enter heating fluid outlet 52 and exit heating fluid inlet 50. Heating fluid 32 can be heated exterior to IEC multi-treater 10 and transfer heat to the process fluid 14 as heating fluid 32 is provided in IEC multi-treater 10. In some embodiments, heating fluid 32 may be heated in heating fluid chamber 48 as heating fluid chamber 48 may comprise heating elements.

In some embodiments, the geometry of IEC multi-treater 10 comprises various features that promote emulsion breaking and coalescence. For example, various geometries of the inner surface (interior to processing chamber 26) of pipe 24 and/or the outer surface of sleeve 38 (interior to processing chamber 26) may be implemented to generate turbulence in the flow of process fluid 14. For example, as shown in FIG. 1B, turbulators 80 may be provided at various locations along the inner surface of pipe 24 and/or the outer surface of sleeve 38 to generate turbulent flow. Similarly, or alternatively, as also shown in FIG. 1B, the inner surface of pipe 24 and/or the outer surface of sleeve 38 may comprise corrugation 82 also causing turbulent flow. Turbulent flow may promote mixing and breaking of the emulsion as well as coalescence of the water droplets. The turbulent flow can increase the mixing of the components of process fluid 14 increasing the likelihood of water droplets interacting with other water droplets increasing coalescence. Furthermore, the turbulent flow can increase the heat transfer capacity of process fluid 14. The heat transfer is described in detail below.

Here, baffles 30 are shown in both processing chamber 26 and heating fluid chamber 48; however, in some embodiments, baffles 30 may be provided in processing chamber 26 only, in heating chamber 48 only, or both; however, baffles 30 may be configured differently in processing chamber 26 and heating chamber 48. As described above, baffles 30 may cause the flow to circulate in a corkscrew-like, undulating, zigzag or some other suitable path. The flow of process fluid 14 and/or heating fluid 32 through processing chamber 26 results in a longer path, or longer effective length of processing chamber 26 and heating chamber 48. The longer effective length of processing chamber 26 and heating fluid chamber 48 also results in a longer effective residence time, or longer time that process fluid 14 and heating fluid 32 are provided in IEC multi-treater 10. Accordingly, the longer effective residence time allows for more heat transfer from heating fluid 32 to process fluid 14.

FIG. 1C illustrates exemplary components of EC cell 12 and an exemplary process of transferring heat into process fluid 14. Heating fluid 32 may transfer heat to process fluid 14 through wall 86 (i.e., the wall that separates processing chamber 26 and heating fluid chamber 48) of processing chamber 26. Furthermore, the turbulent flow described above may assist in distributing the heat throughout process fluid 14 as the more energetic droplets near the interior wall 86 can be distributed throughout the process fluid 14 by the turbulent flow. As illustrated in FIG. 1C the heat provided by heating fluid 32 creates a heat gradient across process fluid 14 from the exterior wall 86 (hottest area) to the sleeve 38 (coolest area).

Furthermore, because of the viscosity of process fluid 14 and under ideal conditions, the flow of the process fluid 14 at the walls of processing chamber 26 is effectively zero providing a typical parabolic velocity profile. As such, process fluid 14 near the exterior wall 86 has the highest residence time and therefore receives the most heat energy from the heating fluid 32. Accordingly, the heat gradient is produced. Inducing turbulence in the flow as described above, may assist in moving process fluid 14 away from the walls and help distribute the heat throughout process fluid 14.

Based on the viscosity of process fluid 14, under ideal conditions, the flow of the process fluid 14 at the walls of processing chamber 26 is effectively zero providing a typical parabolic velocity profile. As such, process fluid 14 near the wall has the highest residence time and therefore is most influenced by the electric field from EC cell 12. The electric field is strongest at sleeve 38. Accordingly, the electric gradient is produced. Inducing turbulence in the flow as described above, may assist in moving process fluid 14 away from the wall of sleeve 38 and help distribute the polarized water droplets throughout process fluid 14 increasing the efficiency of coalescence in process fluid 14.

Near the downstream end of processing chamber 26, or near cross-section 1F, swirl inducers 54 may be provided to generate or facilitate swirling of process fluid 14. In some embodiments, swirl inducers 54 may be configured at an angle to the longitudinal axis such that a vortex motion (e.g., cyclonic motion) is generated in process fluid 14. Because the specific gravity of water is typically greater than that of oil and the oil and water have undergone at least some separation and at least some coalescence at this point, the water droplets may be forced to the outside of the swirling process fluid 14 and oil may be forced to the inside of the vortex. Swirl inducers 54 may also, or only, be provided in the separating chamber 28 in some embodiments. Similarly, the swirling action of process fluid 14 may continue into separating chamber 28. Furthermore, slits 58 may be provided on the interior walls of pipe 24 in separating chamber 28 to allow the separated water to move through the exterior wall of processing chamber 26 into water chamber 60. Once in water chamber 60, water may exit IEC multi-treater 10 through water outlet 56. Water chamber 60 may begin at first water bulkhead 62 and end at second water bulkhead 64 also defining the separating region of IEC multi-treater 10.

In some embodiments, slits 58 may be holes, slits, mesh, a porous material with relatively coarse porosity or the like. Slits 58 may be large enough to allow water droplets to pass while preventing oil chains from passing therethrough. In some embodiments, the separation of oil from the water and the vortex forcing oil to the inside of the vortex and the water to the outside provides that only water is removed from process fluid 14.

Processing chamber bulkhead 70 is illustrated at cross-section 1I. Processing chamber bulkhead 70 may provide the end of processing chamber 26. As such, process fluid 14, which may be above 80% oil at this point, exits IEC multi-treater 10 at process outlet 66. In some embodiments, control valve 72 may be provided at process outlet 66; however, in practice, control valve 72 may be provided downstream of settling tank 74. Furthermore, in some embodiments an additional control valve may be placed downstream of water outlet 56 to widen the operability (e.g. extended flow rate range, fluid viscosity range, and oil/water flow-split range) of the separation chamber 28 of the IEC multi-treater 10. Control valve 72 may be manually, hydraulically, pneumatically, and/or electrically operable (e.g., coupled to an electromechanical actuator). As such, the flow of process fluid 14 may be controlled by control valve 72 either by hand or by computer-executable instructions stored on computer 76 configured to actuate the eletromechanical actuator to control the control valve 72 to allow process fluid 14 to flow through IEC multi-treater 10 and, in some embodiments, into settling tank 74 (e.g., batch separator).

Processing chamber bulkhead 70, in some embodiments, separates processing chamber 26 from electric chamber 68 with a liquidtight and/or gastight seal. Processing chamber bulkhead 70 may also provide placement of electrode 34 by securing sleeve 38 through specific locations in processing chamber bulkhead 70. Here, for example, electrode 34 may be provided in a center of pipe 24, as such, sleeve 38 may be positioned in the center of pipe 24 by processing chamber bulkhead 70 and electrode 34 may run through the center of sleeve 38. Furthermore, an anulus may be provided between sleeve 38 and electrode 34. There should be no gas between electrode 34 and sleeve 38 as gas may ionize with the high voltage of electrode 34 reducing the life of the electrode 34. As such, in some embodiments, oil (e.g., transformer oil) may be provided in the anulus. Electrode 34 and sleeve 38 are described in more detail below.

Penetrator 42 may provide a conduit extending from the outside of IEC multi-treater 10 to the inside providing electrical power from power source 44 to electrode 34. In some embodiments, power may be provided from penetrator 42 to electrode 34 by electrical connector 40. Again, the electrical power may be adjusted by a user interfacing with computer 76 to control the power and, in some embodiments, the power may be automatically controlled based on the measured state of IEC multi-treater 10 and process fluid 14.

In some embodiments, once process fluid 14 has exited process outlet 66, process fluid 14 may be further processed to separate the components of process fluid 14. For example, process fluid 14 may be provided into a settling tank 74. Process fluid 14 may settle in settling tank 74 allowing the heavier components (e.g., water) to settle to the bottom while the lighter components (e.g., oil) are forced to the top. The separated components may then be drained off into separate containers for further processing.

FIG. 2 depicts an embodiment of IEC multi-treater 10 comprising a plurality of EC cells 12 and a plurality of heating fluid chambers 48. It should be noted that the single EC cell 12 IEC multi-treater 10 shown in FIG. 1A is exemplary and a plurality of EC cells 12 each including pipe 24, electrode 34, sleeve 38, processing chamber 26, and any components described above. Cross sections 2A-2F are provided below IEC multi-treater 10 to further clarify the geometry of IEC multi-treater 10.

The operation of the plurality of EC cells 12 in IEC multi-treater 10 may be similar to the operation described above. FIG. 2 depicts a simplified cross-sectional view of the IEC multi-treater 10 comprising a plurality of EC cells 12. Here, housing 46 encompasses seven EC cells 12 that are being held in place by tubesheet 88. Each EC cell 12 comprises an electrode 34 that may be surrounded by a sleeve 38. Here, the electrode 34 and sleeve 38 are depicted as a single object, for simplicity, when the sleeve 38 surrounds the electrode 34 providing an oil-filled anulus therebetween as described above. One or more embodiments of the IEC multi-treater 10 may comprise a plurality of electrodes 34. In some embodiments, there is a single electrode 34 disposed through each pipe 24. In other embodiments, some sleeves 38 may not have an electrode 34 disposed through. Each pipe 24 may surround at least part of a corresponding rod-shaped electrode 34. In one or more embodiments, the electrode 34 may extend past one end of the pipe 24 either towards the process inlet 16 or towards the process outlet 66. In some embodiments, the electrode 34 may extend past both ends of the pipe 24 towards both the process inlet 16 and the process outlet 66. In other embodiments, at one or both ends, the electrode 34 may end approximately even with the pipe 24. In one or more embodiments, either or both ends of electrode 34 may end wholly within pipe 24.

In some embodiments, the pipes 24 are in contact. The contact could be along their entire length or only at a limited number of points. Pipes 24 may comprise a round cross section and may be close-packed, square-packed, or placed in any other packing arrangement. The packing may or may not be optimal. Optimal packing is defined as having the maximum number of tubes for a given housing 46 interior shape. In one or more embodiments, the cross-section of pipes 24 may be a tessellating shape such as a perfect hexagon or a rectangle. Pipes 24 may be arranged in a tessellated fashion. Therefore, in one or more embodiments where the pipe 24 cross-sections may be hexagonal, a collection of pipes 24 may resemble a honeycomb, where a wall may be common between two or more pipes 24.

As illustrated in FIG. 2, the rod-shaped electrodes 34 are arranged concentric in relation to the fluid pipes 24. However, when the pipes 24 are arranged substantially horizontal during use, it may be beneficial to have a little offset or some inclination of electrodes 34 with respect to the centerline of the pipe 24, which is grounded and therefore functions as a grounding cell. In this manner, it is possible to accommodate a free-water stream at the bottom of the EC cell 12 (i.e., the bottom of the pipe 24 of the EC cell 12) without affecting the electro-coalescence performance. Such an offset or inclination may aid in achieving higher coalescence performance and help prevent secondary droplet formation (re-emulsification). In various embodiments, the pipes 24 may be substantially horizontal while the electrodes 34 are inclined or declined, or the pipes 24 may be inclined or declined while electrodes 34 are substantially horizontal. In yet other embodiments, each of the electrodes 34 and pipes 24 may be inclined or declined. As described above, the inclination of the pipes 24/electrode 34 similarly applies to the case of a single EC cell 12 illustrated in FIG. 1A. Furthermore, in some configurations the IEC multi-treater is positioned vertically, as noted by the “TOP” and “BOTTOM” designations in FIGS. 1A, 2 and 3.

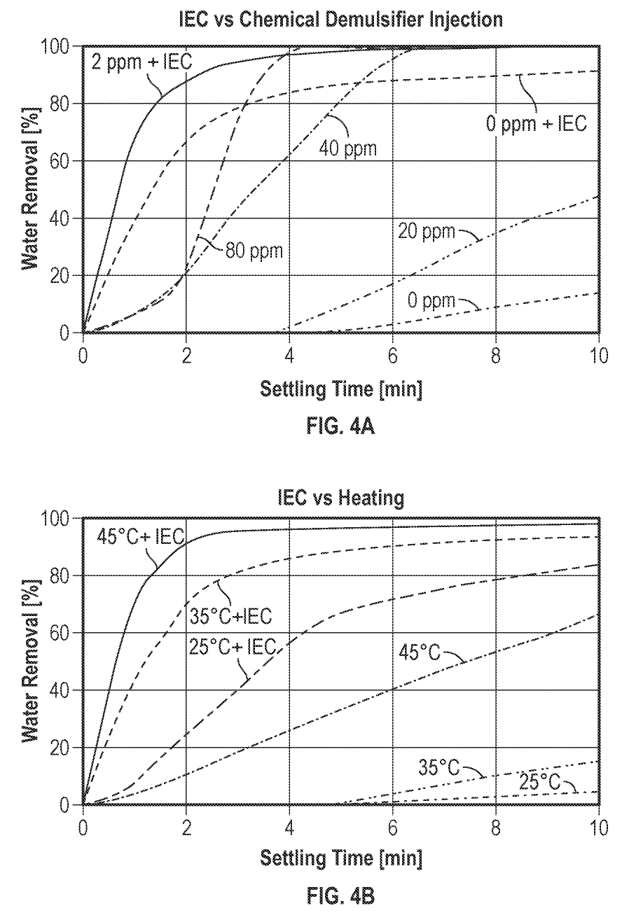

FIG. 3 depicts an exemplary embodiment of IEC multi-treater 10. The exemplary IEC multi-treater 10 arrangement here, illustrates that components described above may be provided in various relative positions and functions may be separated into stages. For example, IEC multi-treater 10 may comprise a plurality of processing chambers 26a, 26b to increase the overall efficiency (e.g., increase the separation of water from the process fluid 14). Here, processing chamber 26 comprises first processing chamber 26a (cross sections 3A-3G) and second processing chamber 26b (cross sections 3G-3K). Processing chambers 26a, 26b, may be configured and function the same as, or similarly to, processing chamber 26 described above. Here, processing chambers 26a, 26b, are provided in line to further increase residence time thus increasing emulsion breaking, coalescence, and ultimately separation. Any number of processing chambers 26a, 26b may be provided in line and may comprise any lengths and dimensions. Furthermore, the embodiment depicted in FIG. 3 may comprise a plurality of EC cells 12 as shown in FIG. 2.

As shown in FIG. 3, processing chamber bulkhead 70 is provided on the upstream side near process inlet 16. Process fluid 14 may enter first processing chamber 26a at process inlet 16. Process fluid 14 may then travel through first processing chamber 26a corkscrewing, undulating, zigzag or some other suitable path around baffles 30a and receiving heat from heating fluid 32 flowing in the opposite direction to the flow of process fluid 14. Heating fluid 32 may flow into first heating fluid chamber 48a through first heating fluid chamber inlet 50a and exit through first heating fluid chamber outlet 52a. Furthermore, the electric field may be provided by electrode 34.

In some embodiments, process fluid 14 may then exit first processing chamber 26a and enter second processing chamber 26b. Here, process fluid 14 may further be heated by heating fluid 32 entering second heating chamber 48b through second heating fluid inlet 50b and exit through second heating fluid outlet 52b. Furthermore, the flow of process fluid 14 may be controlled by baffles 30b extending the effective length of second processing chamber 26b and residence time. Second heating fluid chamber 48b ends at cross section 3J and separating chamber 28 also begins providing slits 58 for receiving the separated water therethrough. Furthermore, swirl inducers 54 may be provided in separating chamber 28 and, in some cases, second processing chamber 26b. Furthermore, swirl element inner cylinder 35 is provided in second processing chamber 26b to support swirl inducers 54 and provide the swirling effect to the process fluid 14. Process fluid 14 then may exit IEC multi-treater 10 at process fluid outlet 66, or process fluid 14 may enter a next processing chamber 26 or separating chamber 28. Furthermore, upon exit from second processing chamber 26, process fluid 14 may enter settling tank 74. Furthermore, in some embodiments, a second electrode (not shown) may be provided in separating chamber 28 to provide additional treatment to process fluid 14 prior to separation. As such, electrical power may be provided by power supply 44 as described above, or by a separate power supply. In some configurations a second bulkhead similar to bulkhead 70 may be provided and separating chamber 28, here, may be configured similarly to separating chamber 28 in FIG. 1A.

In some embodiments, the presence of gas in an anulus formed between the high-voltage electrode 34 and the sleeve 38 (e.g., ceramic insulator), combined with the intense electric field in that region, causes gas ionization and partial discharges. That results in high-frequency noise in the electric circuit of the EC cell 12. The noise can destabilize the electric field reducing performance, reliability, and life expectancy of the EC cell 12. The amount of energy consumed by the unwanted electrical activity in the anulus of the electrode 34 can be extremely large. In some embodiments, an electrical insulating liquid (e.g., transformer oil) is provided in the anulus. The insulating liquid can overheat when the electric field is unstable. The overheated insulating liquid degrades quicky, polluting the electrical components in contact therewith. Furthermore, if gas that is present in the anulus is or includes oxygen, the electrode 34 can degrade (e.g., rust) due to the extremely high temperature, further polluting the insulating liquid. The service life of the electrode 34 and the electrical insulation system can be greatly reduced in this chain-reaction process.

In some embodiments, to reduce the complications described above, the IEC multi-treater 10 may be inclined such that the sleeve 38 (e.g., ceramic insulation) is positioned with an open end higher than a closed end. The anulus can then be filled with the electrical insulating liquid. The insulating liquid can be degassed as it flows into the annulus, filing the anulus while displacing the gas (e.g., air) upwards. Degassing of smaller gas bubbles and of dissolved gas is achieved by applying a vacuum to the upper part of the IEC electric chamber 68. Multiple cycles of vacuum followed by nitrogen gas blanketing can be applied to reduce the presence of oxygen in the insulating liquid to a minimum. Once the cycles are completed, the insulating liquid is left with nitrogen blanketing with some overpressure. As such, the service life is increased by preventing degradation by oxidation, and to make sure gas will not flash out of the insulating fluid when the operating temperature of the system rises. In some embodiments, the preferred position for IEC multi-treater is vertical (as represented by “TOP” and “BOTTOM” illustrated in FIG. 1A and 2), as the vertical arrangement may provide optimal degassing.

In some embodiments, the presence of gas in the emulsion to be treated increases flow velocity and reduces residence time. The total number of cells used in an application where gas is present needs to be increased to keep the average flow velocity of the process fluid 14 within a suitable range. For the same process fluid 14 flow rate, the larger the gas fraction the larger the number of EC cells 12 required. As such, a (considerably) large and less cost-effective system can result. Flow assurance in the piping and/or in the system could also pose a challenge.

In some embodiments, to reduce the complications described above, IEC multi-treater may be deployed in a region of the oil and gas processing system where the gas volume fraction is negligible or none, for example between buster pumps and oil dehydrator/desalter or anywhere in the production system where the gas volume fraction in the oil-continuous emulsion is or has been made sufficiently low or negligible. Furthermore, the emulsion may be degassed upstream of IEC multi-treater 10 with suitable separation equipment. This opens the opportunity for an optimized (system) design involving liquid degassing upstream of IEC multi-treater 10.

Under certain circumstances, EC cell 12 of IEC multi-treater 10 can get partly or totally filled with a water-continuous emulsion, as opposed to an oil-continuous emulsion described above. When that happens, the electric field cannot penetrate the water-flooded portion of the effected EC cells 12 in comparison to the oil-continuous portion. When a majority of EC cell 12 is water-flooded the electric field in the entire EC cell 12 vanishes. Water-flooding occurs when the emulsion entering the EC cell 12 is water-continuous, but water-flooding can also occur when water in an oil-continuous emulsion entering the EC cell 12 settles and accumulates within the EC cell 12. There are several factors that increase the probability of water-flooding including: EC cell 12 inclined with outlet positioned higher than inlet; low flow velocity of process fluid 14; low oil viscosity; high inlet water-cut; and external factors such as inadequate piping or system design.

There is also a plurality of solutions to the issued described above. For example, separating chamber 28 of the IEC multi-treater 10 may be provided at the lower part of the EC cell 12 and use the upper part, or elevated portion (e.g., “TOP”), of EC cell 12 process outlet 66 (FIG. 2) as the inlet (instead of the outlet) and the process inlet 16 as the outlet (instead of the inlet), so the process fluid 14 comprising the emulsion flows downwards rather than upwards. Here, the process fluid 14 flows in the opposite direction as described above but IEC multi-treater 10 is inclined the same. Furthermore, water can be removed upstream from IEC multi-treater 10 such that the water entering IEC multi-treater 10 is already reduced. In some embodiments, as shown in FIG. 1A, EC cell 12 may be positioned above settling tank 74; however, the EC inclination is switched with the “TOP” being the bottom and the “BOTTOM” being the top such that the emulsion through the EC cell 12 moves only downwards. Furthermore, if the EC cell 12 is not above the settling tank 74, a low-shear positive-displacement pump may be provided between the EC cell 12 and the settling tank 74 to prevent water from flowing countercurrent into the EC cell 12. Furthermore, the EC cell 12 may be operated at a relatively high flow velocity. A high velocity may reduce the negative effects described above; however, at some point performance will diminish due to turbulence becoming excessive. As such, the cost between turbulence and water-flooding may be optimized. Furthermore, to reduce water-flooding, the turbulence-inducing features described above may be made of an electrical insulating material, inside the EC cell 12 to prevent the water from settling within the cell. The turbulence inducing features also increase the mobility of droplets across the EC cell 12 and promote droplet-droplet interaction increasing coalescence. The increased mobility means more of the droplets flowing through the EC cell 12 eventually get closer to the electrode 34, where the region where the electric field intensity is higher. The combination results in higher performance and a wider operating envelope.

As described above, swirl inducers 54 may be provided at various locations throughout processing chamber 26. However, providing swirl inducers 54 along sleeve 38, which is ceramic and/or plastic in some embodiments, can be challenging. Typically, swirl blades and the inner cylinder to which they are attached are perfectly bonded together to form one part, without any gap. The gap between the outer edge of swirl inducers 54 and the pipe 24 is also commonly very small and preferably nonexistent in typical systems. Meeting these requirements when the swirl element is in the “middle” of the EC cell, where the swirl’s inner cylinder is a ceramic insulator (i.e., sleeve 38) and the swirl’s outer pipe is the grounding cell (pipe 24 connected to electric ground 36), while the swirl inducer 54 itself is made of an electrical insulating material, without leaving relatively large gaps in between, may pose a significant engineering challenge.

As such, swirl inducers 54 may be placed in various locations throughout IEC multi-treater 10. For example, swirl inducers 54 may be positioned just before electrode 34 proximate and potentially touching the closed end of sleeve 38 but not overlapping with sleeve 38. In some embodiments, swirl inducers 54 and sleeve 38 may comprise the same or similar materials (e.g. metal). As such, the no-gap requirement between swirl blades and sleeve 38 can be easily met. In this embodiment, grounding pipes 24 of the EC cells 12 may be extended accordingly and the required compartments for separation would be provided. Furthermore, in this configuration and as described in embodiments above, process outlet 66 can be the inlet for process fluid 14 and process inlet 16 can be the outlet for process fluid 14. Another advantage of this configuration is that it gives more freedom for the design of the separating chamber 28. For example, oil could be removed from the water by sucking the oil into a hollow swirl core, as well of or instead of the water being pushed out of the separating chamber 28 through slits 58. The swirl core could also be optimized in size (outer diameter) and shape (e.g., the swirl core could be a slender cone instead of a cylinder). Furthermore, in some embodiments, in the multi-cell unit shown in FIG. 2, the quantity of cyclones (e.g., separating chamber 28) does not need to match the number of EC cells 12.

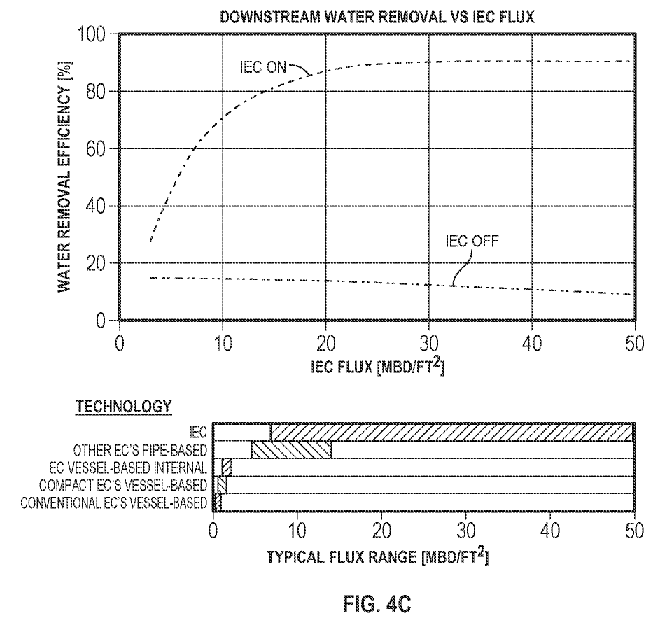

FIG. 4A-4C illustrate exemplary results of an embodiment of IEC multi-treater 10. FIG. 4A depicts exemplary results of water removal vs settling time for process fluid 14 in settling tank 74 after treatment in IEC multi-treater 10. The results show the water removal over time for various quantities of demulsifier 18 injection processed through IEC multi-treater 10 compared to results of various quantities of demulsifier 18 without using IEC multi-treater 10. Here, settling time with 0 parts per million demulsifier 18 and no IEC multi-treater 10 had the lowest water removal rate while utilizing IEC multi-treater 10 with only 2 parts per million demulsifier 18 resulted in the fastest water removal rate.

FIG. 4B depicts exemplary results of water removal vs settling time for process fluid 14 in settling tank 74 after treatment in IEC multi-treater 10 including various heating temperatures compared to settling without IEC multi-treater 10 at various temperatures. Here, the more heat in the process fluid 14 the faster and more water was removed. Furthermore, utilizing the IEC multi-treater 10 processing, the water removal was much faster, and more water was removed over the 10-minute test.

FIG. 4C depicts exemplary results of water removal efficiency vs IEC multi-treater flux in the process fluid 14 for the 10 minutes shown in FIG. 4A-4B. As fluid flux in the IEC multi-treater is increased before transferring process fluid 14 to settling tank 74 turbulence in the processing chamber 26 increases and then separation in the separating chamber 28 and the settling tank 74 also rises, boosting water removal efficiency. The below bar graph illustrates the advantages of IEC multi-treater 10 compared with various standard systems currently in the market.

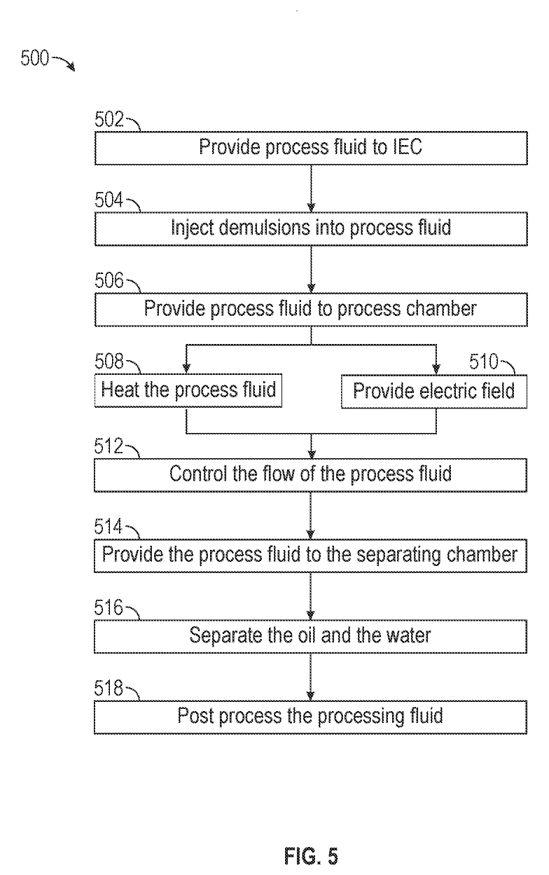

A method of breaking the emulsion and coalescing the emulsion products in an oil and gas process fluid generally referenced by numeral 500 is illustrated in FIG. 5. At step 502, process fluid 14 is provided to process inlet 16 of IEC multi-treater 10. In some embodiments, process fluid 14 is provided to IEC multi-treater 10 from an oil and gas system, including an oil and gas processing plant, an oil treatment plant, an oil refinery, or other facilities providing (bulk) oil dehydration and/or oil desalting. Process fluid 14 may be processed before entering IEC multi-treater 10 and may be received in IEC multi-treater 10 at process inlet 16. Here, process fluid 14 may pass through electrode centralizer 22, which, in some embodiments, may also comprise tubesheet 88 before entering processing chamber 26. Turbulence-inducing features may be provided prior to process fluid 14 entering EC cells 12. The turbulence-inducing features described above, for example porous media with relatively coarse porosity, can be used to control the size of the water droplets prior treatment by EC cell 12.

At step 504, chemicals including chemical demulsifiers 18, corrosion inhibitors, scale inhibitors, and the like may be injected into process fluid 14. Demulsifiers 18 may be any standard chemicals used in the industry. For example, demulsifiers 18 may include alkoxylated alkylphenol-aldehyde resins, polyalkoxylate block copolymers, polyalkoxylated polyols, polyalkoxylated polyamines, and any other demulsifiers in the industry. Demulsifiers 18 may be injected into process fluid 14 by nozzles 20. Furthermore, in some embodiments, nozzles 20 may inject wash water for crude oil desalting as described above. Nozzles 20 may be configured to inject any chemicals that may be used for any purpose in IEC multi-treater 10.

At step 506, process fluid 14 including demulsifiers 18 may be provided to the processing chamber 26. Here, various processes are performed in combination to break the emulsion, promote coalescence, and separate the process fluid into various components.

At step 508, which, in some embodiments, is performed simultaneously with step 510, heating fluid 32 may be provided to heating fluid chamber 48 to heat the process fluid 14. Heating fluid 32 may be provided into heating fluid chamber 48 at heating fluid inlet 50. Heating fluid 32 may flow through heating fluid chamber 48 providing heat to process fluid 14 through the inner wall of pipe 24 and exit heating fluid chamber 48 at heating fluid outlet 52. Here, heating fluid 32 flows in the opposite direction of process fluid 14 because, generally, the opposite flow configuration more efficiently heats the process fluid 14. It should be noted that heating fluid 32 can flow in the same direction as process fluid 14 and the naming of inlets and outlets is simply for convention.

Heating fluid 32 provides heat to process fluid 14 as shown by the heat gradient described above. Providing the heat by heating fluid 32 increases emulsion breaking rate and increases the coalescence of the oil and the coalescence of the water. As such, the emulsion breaking and coalescence is provided in greater quantity at, or near, the inner wall of pipe 24 where residence time is greatest based on the flow and the viscosity of process fluid 14 described above.

At step 510, EC cell 12 provides the electric field to the process fluid 14, which, in some embodiments, occurs simultaneously with step 508. The electric field increases the coalescence of the oil and the coalescence of the water in the process fluid 14 as described above. The electric field may be generated by providing power to electrode 34. The interaction between the electrical energy of electrode 34 and electrical ground of pipe 24 generates an electric field through process fluid 14. Accordingly, the water droplets present in the process fluid 14 polarize, which induces strong attractive forces between the water droplets, coalescing them and breaking the emulsion.

Furthermore, as described above, the electric field is strongest at, or near, sleeve 38 wall based on the viscosity and flow profile of process fluid 14. Accordingly, as described in detail above, the electric field is strongest at the location of highest residence time of process fluid 14 resulting in efficient emulsion breaking and coalescence.

At step 512, the flow of process fluid 14 is controlled by the geometry of the IEC multi-treater 10. In some embodiments, IEC multi-treater 10 may provide various geometric flow control elements such as, for example, baffles 30 and turbulence inducers (e.g., turbulators 80 and corrugation 82), and swirl inducers 54. The geometric flow control elements may be configured to provide various benefits to increase the efficiency of emulsion breaking, coalescence, and separation.

In some embodiments, the flow of process fluid may be controlled by baffles 30. As described in embodiments above, baffles 30 may be provided in processing chamber 26 and heating chamber 48 to control the flow of process fluid 14 and heating fluid 32. Baffles 30 may be provided in exemplary alternating arrangements as illustrated in FIG. 1A-3; however, any arrangement may be provided. The alternating arrangement, in some embodiments, provides a rotating up and down, corkscrew-type, undulating, zigzag or some other suitable flow of process fluid 14 and heating fluid 32. The flow increases the effective length of processing chamber 26 and heating chamber 48 thus increasing the effective residence time of process fluid 14 and heating fluid 32. Increasing the effective residence time increases the time that the other treatments including geometric elements, chemicals, heat, and electric field, act on process fluid. Furthermore, increasing the effective residence time of process fluid 14 and heating fluid 32 increases heat transfer from heating fluid 32.

In some embodiments, turbulence inducers (e.g., turbulators 80 and corrugation 82) may disrupt laminar flow of process fluid 14 to create or increase turbulence. Turbulence inducers may comprise any geometric element that generates turbulence such as corrugation 82 on the inner walls (process fluid side) of pipe 24 and sleeve 38 and turbulators 80 that disrupt laminar flow. Turbulators 80 may also be provided in processing chamber at pipe 24, exterior wall 86, and/or sleeve 38. As described above, turbulence increases the emulsion breaking and coalescence and can further distribute heat throughout process fluid 14.

In some embodiments, swirl inducers 54 generate swirl (e.g., vortex) in process fluid 14. The swirl forces water to the outside of processing chamber 26 near the pipe 24 inner wall and forces the oil to the inside of the vortex near sleeve 38 (in the region of the sleeve 38). Accordingly, the oil and water separate providing the water to the outside such that the water may be removed from the oil in the separating chamber 28.

At step 514, process fluid 14 may exit processing chamber 26 and enter separating chamber 28. The end of the processing chamber 26 may be noted by the end of heating fluid chamber 48 and/or the presence of slits 58 in pipe 24 wall. Here, separating slits 58 may be provided through pipe 24. Slits 58 may be configured to allow the water that has been forced to the outside of the vortex of process fluid 14 to exit IEC multi-treater 10. As the water is forced through slits 58, the water exits IEC multi-treater 10 into a separate chamber and oil is retained at step 516. Process fluid 14 comprising a higher percentage of oil than upstream process fluid 14 may then exit through process outlet 66 to be processed further.

At step 518, process fluid 14 may undergo a post processing procedure. For example, process fluid 14 may be provided into settling tank 74 to be separated from water via gravity. Oil may sink to the bottom of settling tank 74 and water may be forced to the top. As the oil and water separate further, the oil and/or water may be drained off retaining a high percentage of oil for further processing.

In some aspects, the techniques described herein relate to an inline electro-coalescer (IEC) multi-treater.

In some aspects, the techniques described herein relate to an inline electro-coalescer (IEC) multi-treater including one or more nozzles configured to inject chemicals into a process fluid.

In some aspects, the techniques described herein relate to an inline electro-coalescer (IEC) multi-treater further including one or more pipes including a processing chamber configured for the process fluid to flow therethrough.

In some aspects, the techniques described herein relate to an inline electro-coalescer (IEC) multi-treater further including one or more electrodes provided in an electrically insulated sleeve within the processing chamber, wherein the one or more electrodes, in cooperation with the one or more pipes, are configured to provide an electric field through the process fluid in the processing chamber.

In some aspects, the techniques described herein relate to an inline electro-coalescer (IEC) multi-treater further including a plurality of baffles disposed in the processing chamber and configured to control flow of the process fluid through the processing chamber.

In some aspects, the techniques described herein relate to an inline electro-coalescer (IEC) multi-treater further including a heating fluid chamber providing heating fluid proximate to the processing chamber and configured to heat the process fluid in the processing chamber.

In some aspects, the techniques described herein relate to a IEC multi-treater, wherein the plurality of baffles control the process fluid to flow in a corkscrew-like, undulating, zigzag or some other suitable path along a length of the IEC multi-treater increasing an effective length of the processing chamber and increasing the effective residence time of the process fluid within the processing chamber.

In some aspects, the techniques described herein relate to an IEC multi-treater, further including turbulence inducing features provided in the processing chamber, the turbulence inducing features configured to induce turbulence in the flow of the process fluid.

In some aspects, the techniques described herein relate to an IEC multi-treater, wherein the one or more pipes are electrically grounded, and the electric field is generated when power is provided to the one or more electrodes provided in the electrically insulated sleeve.

In some aspects, the techniques described herein relate to an IEC multi-treater, further including: a separating chamber provided downstream of the processing chamber, wherein the separating chamber is configured to separate a component of the process fluid from the process fluid.

In some aspects, the techniques described herein relate to a IEC multi-treater, wherein the separating chamber includes: a separating chamber wall including slits configured to allow the component of the process fluid to flow therethrough; and swirl inducers configured to create a vortex in the process fluid to provide the component of the process fluid to the separating chamber wall.

In some aspects, the techniques described herein relate to a IEC multi-treater, further including a heating fluid inlet and a heating fluid outlet, wherein the heating fluid inlet is disposed upstream from the heating fluid outlet causing the heating fluid to flow in an opposite direction than that of the process fluid.

In some aspects, the techniques described herein relate to an IEC multi-treater, wherein the chemicals are demulsifiers configured to break an emulsion of the process fluid or wash water fluid configured for desalting of crude oil.

In some aspects, the techniques described herein relate to an inline electro-coalescer (IEC) multi-treater configured to coalesce components of a process fluid, the IEC multi-treater including: one or more nozzles configured to inject chemicals into the process fluid; one or more pipes including a processing chamber configured for the process fluid to flow therethrough, wherein the one or more pipes are electrically grounded; one or more electrodes provided in one or more electrically insulated sleeves surrounded by the processing chamber; wherein the one or more electrodes, in cooperation with the one or more pipes, are configured to provide an electric field through the process fluid in the processing chamber; a plurality of baffles disposed in the processing chamber and configured to control flow of the process fluid through the processing chamber; a heating fluid chamber provided proximate to the processing chamber and configured to heat the process fluid in the processing chamber; and a separating chamber configured separate the process fluid by at least partially removing a component of the process fluid from the process fluid.

In some aspects, the techniques described herein relate to an IEC multi-treater, wherein the one or more electrodes is elevated on a first end relative to a second end preventing re-emulsification.

In some aspects, the techniques described herein relate to an IEC multi-treater, wherein a material of the one or more electrically insulated sleeves includes ceramic and is centered within the one or more pipes and the one or more electrodes is centered within the one or more electrically insulated sleeves.

In some aspects, the techniques described herein relate to an IEC multi-treater, wherein the processing fluid includes water and oil and wherein the component that is at least partially separated from the process fluid is the water.

In some aspects, the techniques described herein relate to an IEC multi-treater, further including: a settling tank at a process fluid outlet, wherein the settling tank is configured to provide settling of the process fluid further separating the water from the oil.

In some aspects, the techniques described herein relate to an IEC multi-treater, wherein the chemicals are configured for breaking an oil-water emulsion and/or desalting of crude oil.

In some aspects, the techniques described herein relate to a method of separating a component of a process fluid by an inline electro-coalescer (IEC) multi-treater.

In some aspects, the techniques described herein relate to a method of separating a component of a process fluid by an inline electro-coalescer (IEC) multi-treater, the method including receiving the process fluid in an inlet.

In some aspects, the techniques described herein relate to a method of separating a component of a process fluid by an inline electro-coalescer (IEC) multi-treater, the method further including providing demulsifiers to the process fluid.

In some aspects, the techniques described herein relate to a method of separating a component of a process fluid by an inline electro-coalescer (IEC) multi-treater, the method including providing the process fluid to a processing chamber, wherein the processing chamber is provided in an electrically grounded pipe.

In some aspects, the techniques described herein relate to a method of separating a component of a process fluid by an inline electro-coalescer (IEC) multi-treater, the method including heating the process fluid by a heating fluid flowing through a heating fluid chamber adjacent to the processing chamber.

In some aspects, the techniques described herein relate to a method of separating a component of a process fluid by an inline electro-coalescer (IEC) multi-treater, the method including generating an electric field by an electrode in cooperation with the electrically grounded pipe, wherein the electrode is disposed in an electrically insulated sleeve within the processing chamber.

In some aspects, the techniques described herein relate to a method of separating a component of a process fluid by an inline electro-coalescer (IEC) multi-treater, the method including at least partially separating at least one component from the process fluid in a separating chamber.

In some aspects, the techniques described herein relate to a method, further including controlling the flow of the process fluid by baffles disposed along a length of the IEC multi-treater increasing an effective length of the processing chamber and increasing the effective residence time of the process fluid within the processing chamber.

In some aspects, the techniques described herein relate to a method, further including inducing turbulence in the flow of the process fluid in the processing chamber by one or more turbulence inducing features.

In some aspects, the techniques described herein relate to a method, further including: inducing a vortex in the flow of the process fluid by swirl inducers, wherein the vortex separates oil and water in the process fluid; and removing the water from the process fluid by slits disposed in a separating chamber wall.

In some aspects, the techniques described herein relate to a method, further including: providing the heating fluid to the heating fluid chamber by a heating fluid inlet provided upstream from a heating fluid outlet and causing the heating fluid to flow in an opposite direction to the process fluid.

In some aspects, the techniques described herein relate to a method, wherein the processing fluid includes water and oil and wherein the component that is partially separated from the process fluid is the water; and wherein the method further includes: providing the process fluid in a settling tank; and further separating the water from oil in the settling tank.

The following patent applications are each hereby incorporated by reference in their entirety as if set forth herein verbatim: U.S. Patent No. 11,607,626 entitled ADAPTER FOR ELECTRO-COALESCER INSULATED ELECTRODES WITH METAL SEALING FOR ELECTRODES filed on Jan. 3, 2020; U.S. Patent No. 12,139,424 entitled ELECTRO-COALESCER CELL WITH TURBULENCE-INDUCING SHAPE FOR MAXIMIZED PERFORMANCE filed on Jan. 3, 2020; Australian Patent Application No. 2015/203,344 entitled ELECTROSTATIC COALESCER WITH RESONANCE TRACKING CIRCUIT filed on Jun. 17, 2015.

Although the invention has been described with reference to the embodiments illustrated in the attached drawing figures, it is noted that equivalents may be employed, and substitutions made herein without departing from the scope of the invention.

Having thus described various embodiments of the disclosure, what is claimed as new and desired to be protected by Letters Patent includes the following:

1. An inline electro-coalescer (IEC) multi-treater, comprising:
one or more nozzles configured to inject chemicals into a process fluid;
one or more pipes comprising a processing chamber configured for the process fluid to flow therethrough;
one or more electrodes provided in an electrically insulated sleeve within the processing chamber;
wherein the one or more electrodes, in cooperation with the one or more pipes, are configured to provide an electric field through the process fluid in the processing chamber;
a heating fluid chamber providing heating fluid proximate to the processing chamber and configured to heat the process fluid in the processing chamber; and
a plurality of baffles disposed in the processing chamber and configured to control flow of the process fluid through the processing chamber.

2. The IEC multi-treater of claim 1, wherein the plurality of baffles controls the process fluid and/or the heating fluid to flow in a corkscrew-like, undulating, or zig-zag-like, path along a length of the IEC multi-treater increasing an effective length of the processing chamber and/or heating fluid chamber and increasing an effective residence time of the process fluid and/or heating fluid.

3. The IEC multi-treater of claim 1, further comprising turbulence inducing features provided in the processing chamber, the turbulence inducing features configured to induce turbulence in the flow of the process fluid.

4. The IEC multi-treater of claim 1, wherein the one or more pipes are electrically grounded, and the electric field is generated when power is provided to the one or more electrodes provided in the electrically insulated sleeve.

5. The IEC multi-treater of claim 1, further comprising:
a separating chamber provided downstream of the processing chamber,
wherein the separating chamber is configured to separate a component of the process fluid from the process fluid.

6. The IEC multi-treater of claim 5, wherein the separating chamber comprises:
a separating chamber wall comprising slits configured to allow the component of the process fluid to flow therethrough; and
swirl inducers configured to create a vortex in the process fluid to provide the component of the process fluid to the separating chamber wall.

7. The IEC multi-treater of claim 1, further comprising a heating fluid inlet and a heating fluid outlet, wherein the heating fluid inlet is disposed upstream from the heating fluid outlet causing the heating fluid to flow in an opposite direction than that of the process fluid.

8. The IEC multi-treater of claim 1, wherein the chemicals are demulsifiers configured to break an emulsion of the process fluid and/or wash water fluid configured for desalting of crude oil.

9. An inline electro-coalescer (IEC) multi-treater configured to coalesce components of a process fluid, the IEC multi-treater comprising:
one or more nozzles configured to inject chemicals into the process fluid;
one or more pipes comprising a processing chamber configured for the process fluid to flow therethrough,
wherein the one or more pipes are electrically grounded;
one or more electrodes provided in one or more electrically insulated sleeves surrounded by the processing chamber;
wherein the one or more electrodes, in cooperation with the one or more pipes, are configured to provide an electric field through the process fluid in the processing chamber;
a heating fluid chamber provided proximate to the processing chamber and configured to heat the process fluid in the processing chamber;
a plurality of baffles disposed in at least the processing chamber and configured to control flow of the process fluid through the processing chamber; and
a separating chamber configured separate the process fluid by at least partially removing a component of the process fluid from the process fluid.

10. The IEC multi-treater of claim 9, wherein the one or more electrodes is elevated on a first end relative to a second end preventing re-emulsification.

11. The IEC multi-treater of claim 9, wherein a material of the one or more electrically insulated sleeves comprises ceramic and is centered within the one or more pipes and the one or more electrodes is centered within the one or more electrically insulated sleeves.

12. The IEC multi-treater of claim 9, wherein the processing fluid comprises water and oil and wherein the component that is at least partially separated from the process fluid is the water.

13. The IEC multi-treater of claim 12, further comprising:
a settling tank at a process fluid outlet,
wherein the settling tank is configured to provide settling of the process fluid further separating the water from the oil.

14. The IEC multi-treater of claim 13, wherein the chemicals are configured for breaking an oil-water emulsion and/or desalting of crude oil.

15. A method of separating a component of a process fluid by an inline electro-coalescer (IEC) multi-treater, the method comprising:
receiving the process fluid in an inlet;
providing demulsifiers to the process fluid;
providing the process fluid to a processing chamber, wherein the processing chamber is provided in an electrically grounded pipe;
heating the process fluid by a heating fluid flowing through a heating fluid chamber adjacent to the processing chamber;
generating an electric field by an electrode in cooperation with the electrically grounded pipe, wherein the electrode is disposed in an electrically insulated sleeve within the processing chamber; and
at least partially separating at least one component from the process fluid in a separating chamber.

16. The method of claim 15, further comprising controlling the flow of the process fluid and/or the heating fluid by baffles disposed along a length of the IEC multi-treater increasing an effective length of the processing chamber and/or the heating fluid chamber and increasing effective residence time of the process fluid and/or the heating fluid.

17. The method of claim 15, further comprising inducing turbulence in the flow of the process fluid in the processing chamber by one or more turbulence inducing features.

18. The method of claim 15, further comprising:
inducing a vortex in the flow of the process fluid by swirl inducers,
wherein the vortex separates oil and water in the process fluid; and
removing the water from the process fluid by slits disposed in a separating chamber wall.

19. The method of claim 15, further comprising:
providing the heating fluid to the heating fluid chamber by a heating fluid inlet provided upstream from a heating fluid outlet; and
causing the heating fluid to flow in an opposite direction to the process fluid.

20. The method of claim 15,
wherein the processing fluid comprises water and oil and wherein the component that is partially separated from the process fluid is the water; and
wherein the method further comprises:
providing the process fluid in a settling tank; and
further separating the water from oil in the settling tank.
